(19) United States
(12) Patent Application Publication
(10) Pub. No.: US 2007/0050192 A1
(43) Pub. Date: Mar. 1, 2007

(54) Enhanced collaborative filtering technique for recommendation

(75) Inventors: Srinivas Gutta, Veldhoven (NL); Petrus Gerardus Meuleman, Eindhvoven (NL); Wilhelmus Franciscus Johannes Verhaegh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,166

(22) PCT Filed: Nov. 30, 2004
(86) PCT No.: PCT/IB04/52605

§ 371 Date: Jun. 2, 2006

Related U.S. Application Data
(60) Provisional application No. 60/526,755, filed on Dec. 3, 2003.

(51) Int. Cl. G06Q 99/00

(52) U.S. Cl. 705/1; 705/500

(57) ABSTRACT

A method for generating a recommendation for a user is provided. The method includes: identifying a first group of other users, the first group having a plurality of first individuals associated with user preferences and/or user profiles that are considered positive influences in generating a recommendation; and generating the recommendation for the user based on the user preferences and/or user profiles of the first individuals. The method can further include: identifying a second group of other users, the second group having a plurality of second individuals associated with user preferences and/or user profiles that are considered negative influences in generating a recommendation; where the generating of the recommendation is further based on the user preferences and/or user profiles of the second individuals.

The present invention relates generally to recommendation systems, and more particularly to an enhanced collaborative filtering technique for recommendation.

Recommendation systems are well known in the art. Such recommendation systems generally build a user profile for one or more users of the system based on the content of the user's viewing history. A problem with content-based recommendation methods is a great effort is required to develop case representations and similarity models. Also, since content-based methods make recommendations based on item similarity, the newly recommended items tend to be quite similar to the past items leading to a reduced diversity in recommendations.

Collaborative recommendations methods on the other hand are an alternative to content-based techniques. Collaborative recommendations methods recommend items of interest based on what similar users have liked in the past. They achieve this via a similarity metric, which computes the differences between the likings of the target user and other users. This computation process is quite expensive due to the need for the system to rank all the available users and find users that have similar tastes. In addition, a problem with the current collaborative approaches is that, by recommending shows, which have been liked by a majority of users with similar tastes, does not necessarily imply that they would be liked by the target user. Since, taste is subjective, it is important for the recommendation system to allow the target user to identify a set of users whose tastes he/she believes in, and users that have an opposite taste.

Therefore it is an object of the present invention to provide methods and systems that overcome these and other disadvantages associated with the prior art.

Accordingly, a method for generating a recommendation for a user is provided. The method comprising: identifying a first group of other users, the first group of other users having a plurality of first individuals each associated with at least one of user preferences and user profiles that are considered positive influences in generating a recommendation for the user; and generating the recommendation for the user based on at least one of the user preferences and user profiles of one or more of the plurality of first individuals in the first group.

Where the generating is based on the user profile of one or more of the plurality of first individuals in the first group, the method can further comprise: obtaining permission from each of the first individuals corresponding to each of the user profiles used to generate the recommendation; and storing each of the user profiles.

The method can further comprise: identifying a second group of other users, the second group of other users having a plurality of second individuals each associated with at least one of user preferences and user profiles that are considered negative influences in generating a recommendation for the user; and wherein the generating of the recommendation for the user is further based on at least one of the user preferences and user profiles of one or more of the plurality of second individuals in the second group. The generating comprises: generating the recommendation based on at least one of the user preferences and user profiles of one or more of the plurality of first individuals in the first group; and filtering the recommendation against at least one of the user preferences and user profiles of one or more of the plurality of second individuals in the second group.

The method can further comprise assigning a weight to one or more of the plurality of first individuals in the first group, the weight being a factor by which each of the plurality of first individuals is considered in generating the recommendation. The assigning can comprise the user assigning the weight to one or more of the plurality of first individuals in the first group.

The first group can comprise two or more first groups, in which case the method can further comprise assigning a weight to each of the two or more first groups, the weight being a factor by which each of the two or more first groups is considered in generating the recommendation. The assigning can comprise the user assigning the weight to each of the two or more first groups.

Where at least one of the user preferences and user profile corresponding to the one or more of the plurality of first individuals in the first group have one or more characteristics, the method can further comprise assigning a weight to each of the one or more characteristics, the weight being a factor by which each of the one or more characteristics is considered in generating the recommendation. The assigning can comprise the user assigning the weight to each of the one or more characteristics.

The method can further comprise assigning a weight to one or more of the plurality of second individuals in the second group, the weight being a factor by which each of the plurality of second individuals is considered in generating the recommendation. The assigning can comprise the user assigning the weight to one or more of the plurality of second individuals in the second group.

The second group can comprise two or more second groups, in which case the method can further comprise assigning a weight to each of the two or more second groups, the weight being a factor by which each of the two or more second groups is considered in generating the recommendation. The assigning comprises the user assigning the weight to each of the two or more second groups.

Where at least one of the user preferences and user profile corresponding to the one or more of the plurality of second individuals in the second group have one or more characteristics, the method can further comprise assigning a weight to each of the one or more characteristics, the weight being a factor by which each of the one or more characteristics is considered in generating the recommendation. The assigning can comprise the user assigning the weight to each of the one or more characteristics.

The identifying can comprise the user identifying the plurality of first individuals in the first group. The identifying can comprise the user identifying the plurality of second individuals in the second group.

The identifying can comprise automatically generating the plurality of first individuals in the first group. The automatically generating can comprise: determining an extent to which other users from an available set of other users were useful towards generating a recommendation; and selecting those other users as candidates for the first group whose extent is greater than a predetermined threshold. In which case, the method can further comprise presenting the selected other users to the user for selection of the first individuals in the first group.

The identifying can comprise automatically generating the plurality of second individuals in the second group. The automatically generating can comprise: determining an extent to which other users from an available set of other users were useful towards generating a recommendation; and selecting those other users as candidates for the second group whose extent is less than a predetermined threshold. In which case the method can further comprise presenting the selected other users to the user for selection of the second individuals in the second group.

The recommendation can be a television program recommendation.

Also provided is an apparatus for generating a recommendation. The apparatus comprising: means for identifying a first group of other users, the first group of other users having a plurality of first individuals each associated with at least one of user preferences and user profiles that are considered positive influences in generating a recommendation for the user; and a recommender for generating the recommendation for the user based on at least one of the user preferences and user profiles of one or more of the plurality of first individuals in the first group.

The apparatus can further comprise: means for identifying a second group of other users, the second group of other users having a plurality of second individuals each associated with at least one of user preferences and user profiles that are considered negative influences in generating a recommendation for the user; and wherein the generating of the recommendation by the recommender is further based on at least one of the user preferences and user profiles of one or more of the plurality of second individuals in the second group.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

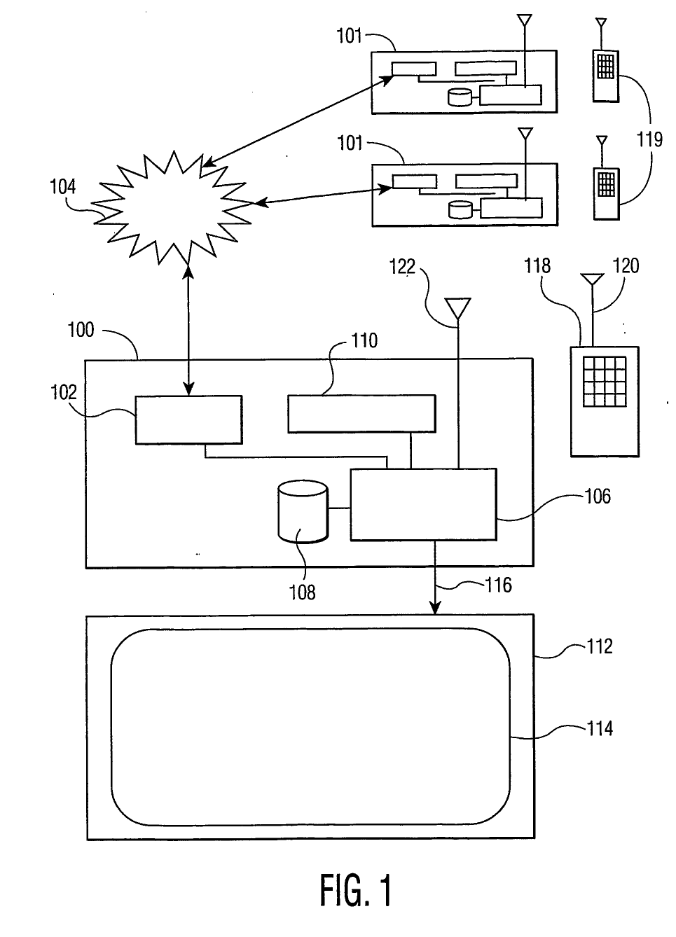

FIG. 1 illustrates an embodiment of a television recommender of the present invention.

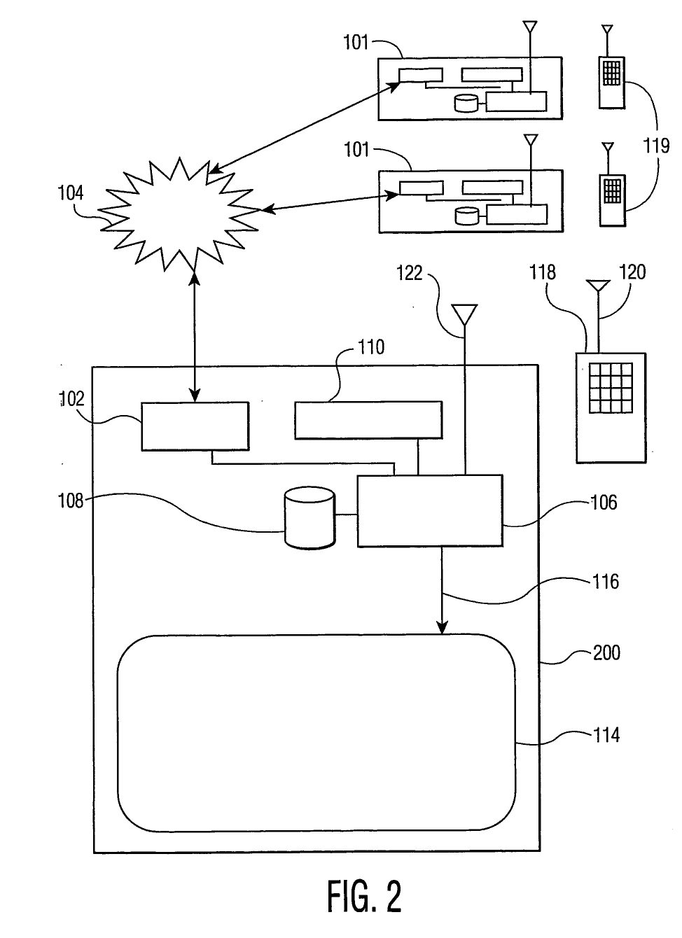

FIG. 2 illustrates another embodiment of the television recommender of FIG. 1.

Although this invention is applicable to numerous and various types of recommenders, it has been found particularly useful in the environment of television program recommenders. Therefore, without limiting the applicability of the invention to television program recommenders, the invention will be described in such environment. However, those skilled in the art will appreciate that the recommenders of the present invention have application in other environments, such as radio program recommenders, advertisement recommenders, and recommenders for goods and/or services.

Referring now to FIG. 1, there is shown implementation of an apparatus for generating a recommendation for video content to a viewer, the apparatus being generally referred to by reference numeral 100. The apparatus may be a set-top box, such as a personal video recorder (PVR), as are known in the art, such as Replay TV® and TiVo®. Such PVR's are well known in the art. In general, PVR's recommend video content, such as television shows, based on a user profile of the viewer stored in memory. The user profile indicates viewing preferences of the viewer based on the viewing history of a viewer and/or manual input by the viewer. For purposes of this disclosure, “viewer” shall mean that person for whom the video content is being recommended and “users” shall mean those persons corresponding to the plurality of users in remote locations from the viewer. The users in the remote locations each may have a similarly equipped apparatus to that of apparatus 100 to the extent that they can also recommend video content, the apparatus of the users being referred to by reference numeral 101, such apparatus 101 are assumed to include similar features to that of apparatus 100. However, those skilled in the art will appreciate that apparatus 101 can be configured differently from apparatus 100 and still cooperate to perform the methods of the present invention. For example, the apparatus 101 of the user may be configured to build and store a user profile and/or user preferences of the user but may not be capable of generating a recommendation.

The apparatus 100 generally has a means for receiving user preferences and/or user profiles from the users, such as a modem 102 operating over a telephone network 104, for accessing at least one of the other user apparatus 101 and to receive the user preferences and/or user profiles stored within the apparatus 101. However, the means for receiving user preferences and/or user profiles from the users can also comprise storing such information on a portable storage device, such as a CD, DVD, or floppy diskette and providing the apparatus 100 with a means for reading the same from the portable storage device. As will be discussed below, the users can be separated into groups of users. One or more first groups can include individual users who are considered positive influences for the purpose of generating a recommendation for the viewer. The first groups are alternatively referred to as “friends” groups. One or more second groups can include individual users who are considered negative influences for the purpose of generating a recommendation for the viewer. The second groups are alternatively referred to as “non-friends” groups.

The apparatus 100 further has a processor 106. As will be discussed below, a function of the processor, in addition to carrying out the typical functions of the apparatus 100, is to determine a recommendation for the viewer based on at least one of the user preferences and user profiles of one or more of the individuals in the friends group and possibly also on at least one of the user preferences and user profiles of one or more of the individuals in the non-friends group. The processor has a storage device 108 operatively connected thereto to store user profiles of the viewer, as well as video content, and instructions for carrying out the methods of the present invention and the typical functions of the apparatus 100. Although shown as a single storage device 108, more than one storage device can be provided for storing any one or more of the above. The apparatus further has a recommender 110 (alternatively known in the art as a recommendation engine) for determining a recommendation for video content based on a user profile. As will be discussed below, the recommender 110 will determine a recommendation based on the positive influences of one or more of the individuals in the friends group and may also determine the recommendation based on the negative influences of one or more of the individuals in the non-friends group.

Apparatus 100 further has a monitor 112 operatively connected thereto for displaying video content supplied by the apparatus 100 on a display 114 via signal line 116. The monitor 112 can be a television for receiving a broadcast, cable, or satellite signal, or a computer monitor for receiving a streaming video signal. The monitor 112 can also display a user interface generated by the apparatus 100 for inputting instructions to the apparatus 100. Specifically, as will be discussed below, the viewer can select or indicate the individual users who form the first and second groups from a suitable user interface displayed on the monitor 112. As will also be discussed below, the viewer may also use the user interface to assign weights to the groups, individuals in the groups, and/or characteristics of the user preferences and/or user profiles corresponding to any of the individuals in the groups. Construction of such a user interface is well within the knowledge of those of ordinary skill in the art, and as such, a detailed description thereof is omitted for the sake of brevity. The apparatus 100 further has a means for engaging with the user interface, such as a remote control 118. The remote control may be wireless, as are known in the art, and having a transmitter 120 in wireless communication with a receiver 122 operatively connected to the processor 106. The apparatus 101 corresponding to the other users are preferably similarly equipped with a remote control 119 and a user interface for interfacing with their apparatus 101, such as providing approval for transmitting their user interface to the viewer.

FIG. 2 illustrates another embodiment of the recommender in which like features are referred to by like reference numerals. In the system of FIG. 2, the recommender is integral with the monitor, referred to by reference numeral 200. The monitor 200 can be a television for receiving a broadcast, cable, or satellite signal, or a computer monitor for receiving a streaming video signal.

Methods for generating a recommendation will now be discussed with reference to FIGS. 1 and 2. Instead of computing the similarity between the viewer and all the available users in the database for whom the preference information is available (as is done in the prior art techniques), the methods of the present invention permit the viewer to suggest to the apparatus 100, 200 which users it should rely on in generating a recommendation. Specifically the friends group (“positive influences”) or an extended friends list could be created by the viewer. The recommendation for the user can be generated based on at least one of the user preferences and user profiles of one or more of the individuals in the friends group. Each of the individuals in the friends group are associated with user preferences and/or user profiles that are considered positive influences in generating a recommendation for the user. The advantage of such an approach is that, the apparatus no longer has to check among all the users to find users with similar tastes. If the generation of the recommendation is based on the user profile of one or more of the individuals in the friends group, then permission should be obtained from such individuals. The individuals can grant such permission through a suitable user interface at apparatus 101. Furthermore, the user profiles of the individuals granting such permission can be stored at the storage device 108. A similar scheme can be used where user profiles of individuals from the non-friends list are used in generating the recommendation.

The viewer could also give weights to the list globally or to individual people in the lists. Weights could be further given based on specific characteristics of the user preferences and/or user profiles. Thus, the viewer can assign a weight to one or more of the individuals in the friends group, where the weight is a factor by which each of the plurality of individuals is considered in generating the recommendation. If more than one friends group is provided, the viewer can also assign a weight to each of the friends groups, where the weight is a factor by which each of the friends groups is considered in generating the recommendation. Furthermore, where at least one of the user preferences and user profiles corresponding to one or more of the individuals in the friends group have one or more characteristics (such as time of day, day of week), the viewer can also assign a weight to each of the characteristics, where the weight is a factor by which each of the characteristics is considered in generating the recommendation. The user can assign any of the weights discussed above, such as through a suitable user interface.

In addition, the apparatus 100, 200 can also provide the option for the viewer to specify a non-friends group of individuals whose tastes the viewer does not like at all (“negative influences”). Each of the individuals in the non-friends group is associated with user preferences and/or user profiles that are considered negative influences in generating a recommendation for the user. Where the friends and non-friends groups are both used to generate a recommendation for the viewer, the recommendation is also based on at least one of the user preferences and user profiles of one or more of the individuals in the non-friends group. In cases when both the friends group and the non-friends group are used to generate the recommendation, the apparatus first finds the television programs (or other subject matter being recommended) that have been previously liked by the individuals in the friends group. Next it filters the television programs such that the individuals in the non-friends group have not liked these television programs. This filtering could also be dependent on any of the weights discussed above with regard to the friends group. Furthermore, as discussed above with regard to the friends group, the weights can be provided by the viewer.

The viewer can also identify the individuals in the friends and/or non-friends groups. The viewer can identify such individuals through a suitable user interface and a data entry means such as the remote control 118 or a keyboard (not shown). Alternatively, instead of the viewer providing the friends and non-friends groups to the apparatus, the apparatus 100, 200, the processor 106 could automatically create the groups, by partitioning an available set of users into friends and non-friends groups based on how much of their past preference history was useful towards recommendations. Next, it could present this group to the viewer and allow the viewer to decide which users to keep and which to remove or the system could further tailor these users by ranking them. In this way, the viewer has more control and insight into which influencers to choose and keep. Again, the viewer can identify which individuals to keep and which to remove through a suitable user interface.

The methods of the present invention may be carried out by a computer software program, such computer software program may contain modules corresponding to the individual steps of the methods. Such software can of course be embodied in a computer-readable medium, such as an integrated chip or a peripheral device.

While there has been shown and described what is considered to be illustrative embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for generating a recommendation for a user, the method comprising:
identifying a first group of other users, the first group of other users having a plurality of first individuals each associated with at least one of user preferences and user profiles that are considered positive influences in generating a recommendation for the user; and
generating the recommendation for the user based on at least one of the user preferences and user profiles of one or more of the plurality of first individuals in the first group.

2. The method of claim 1, wherein the generating is based on the user profile of one or more of the plurality of first individuals in the first group, the method further comprising:
obtaining permission from each of the first individuals corresponding to each of the user profiles used to generate the recommendation; and
storing each of the user profiles.

3. The method of claim 1, further comprising:
identifying a second group of other users, the second group of other users having a plurality of second individuals each associated with at least one of user preferences and user profiles that are considered negative influences in generating a recommendation for the user; and
wherein the generating of the recommendation for the user is further based on at least one of the user preferences and user profiles of one or more of the plurality of second individuals in the second group.

4. The method of claim 3, wherein the generating comprises:
generating the recommendation based on at least one of the user preferences and user profiles of one or more of the plurality of first individuals in the first group; and
filtering the recommendation against at least one of the user preferences and user profiles of one or more of the plurality of second individuals in the second group.

5. The method of claim 1, further comprising assigning a weight to one or more of the plurality of first individuals in the first group, the weight being a factor by which each of the plurality of first individuals is considered in generating the recommendation.

6. The method of claim 5, wherein the assigning comprises the user assigning the weight to one or more of the plurality of first individuals in the first group.

7. The method of claim 1, wherein the first group comprises two or more first groups, the method further comprising assigning a weight to each of the two or more first groups, the weight being a factor by which each of the two or more first groups is considered in generating the recommendation.

8. The method of claim 7, wherein the assigning comprises the user assigning the weight to each of the two or more first groups.

9. The method of claim 1, wherein at least one of the user preferences and user profile corresponding to the one or more of the plurality of first individuals in the first group have one or more characteristics, the method further comprising assigning a weight to each of the one or more characteristics, the weight being a factor by which each of the one or more characteristics is considered in generating the recommendation.

10. The method of claim 9, wherein the assigning comprises the user assigning the weight to each of the one or more characteristics.

11. The method of claim 3, further comprising assigning a weight to one or more of the plurality of second individuals in the second group, the weight being a factor by which each of the plurality of second individuals is considered in generating the recommendation.

12. The method of claim 11, wherein the assigning comprises the user assigning the weight to one or more of the plurality of second individuals in the second group.

13. The method of claim 3, wherein the second group comprises two or more second groups, the method further comprising assigning a weight to each of the two or more second groups, the weight being a factor by which each of the two or more second groups is considered in generating the recommendation.

14. The method of claim 13, wherein the assigning comprises the user assigning the weight to each of the two or more second groups.

15. The method of claim 3, wherein at least one of the user preferences and user profile corresponding to the one or more of the plurality of second individuals in the second group have one or more characteristics, the method further comprising assigning a weight to each of the one or more characteristics, the weight being a factor by which each of the one or more characteristics is considered in generating the recommendation.

16. The method of claim 15, wherein the assigning comprises the user assigning the weight to each of the one or more characteristics.

17. The method of claim 1, wherein the identifying comprises the user identifying the plurality of first individuals in the first group.

18. The method of claim 3, wherein the identifying comprises the user identifying the plurality of second individuals in the second group.

19. The method of claim 1, wherein the identifying comprises automatically generating the plurality of first individuals in the first group.

20. The method of claim 19, wherein the automatically generating comprises:
determining an extent to which other users from an available set of other users were useful towards generating a recommendation; and
selecting those other users as candidates for the first group whose extent is greater than a predetermined threshold.

21. The method of claim 20, further comprising presenting the selected other users to the user for selection of the first individuals in the first group.

22. The method of claim 3, wherein the identifying comprises automatically generating the plurality of second individuals in the second group.

23. The method of claim 22, wherein the automatically generating comprises:
determining an extent to which other users from an available set of other users were useful towards generating a recommendation; and
selecting those other users as candidates for the second group whose extent is less than a predetermined threshold.

24. The method of claim 23, further comprising, presenting the selected other users to the user for selection of the second individuals in the second group.

25. The method of claim 1, wherein the recommendation is a television program recommendation.

26. An apparatus for generating a recommendation, the apparatus comprising:
means (106, 118) for identifying a first group of other users, the first group of other users having a plurality of first individuals each associated with at least one of user preferences and user profiles that are considered positive influences in generating a recommendation for the user; and
a recommender (110) for generating the recommendation for the user based on at least one of the user preferences and user profiles of one or more of the plurality of first individuals in the first group.

27. The apparatus of claim 26, further comprising:
means (106, 118) for identifying a second group of other users, the second group of other users having a plurality of second individuals each associated with at least one of user preferences and user profiles that are considered negative influences in generating a recommendation for the user; and
wherein the generating of the recommendation by the recommender is further based on at least one of the user preferences and user profiles of one or more of the plurality of second individuals in the second group.

28. A computer program product embodied in a computer-readable medium for generating a recommendation for a user, the computer program product comprising:
computer readable program code means for identifying a first group of other users, the first group of other users having a plurality of first individuals each associated with at least one of user preferences and user profiles that are considered positive influences in generating a recommendation for the user; and
computer readable program code means for generating the recommendation for the user based on at least one of the user preferences and user profiles of one or more of the plurality of first individuals in the first group.

29. A program storage device readable by machine, tangibly embodying a program of instructions executable by the machine to perform method steps for generating a recommendation for a user, the method comprising:
identifying a first group of other users, the first group of other users having a plurality of first individuals each associated with at least one of user preferences and user profiles that are considered positive influences in generating a recommendation for the user; and
generating the recommendation for the user based on at least one of the user preferences and user profiles of one or more of the plurality of first individuals in the first group.
